(19) United States
(12) Patent Application Publication
(10) Pub. No.: US 2026/0177033 A1
(43) Pub. Date: Jun. 25, 2026

(54) FASTENING ARRANGEMENT AND WIND TURBINE

(71) Applicants: ZF FRIEDRICHSHAFEN AG, Friedrichshafen (DE); ZF Wind Power Antwerpen N.V., Lommel (BE)

(72) Inventors: Priyangu PATEL, Friedrichshafen (DE); Wim DE LAET, Antwerpen (BE); Benjamin MARRANT, Wezembeek-Oppem (BE)

(21) Appl. No.: 19/422,494

(22) Filed: Dec. 17, 2025

(30) Foreign Application Priority Data
Dec. 20, 2024 (DE) 10 2024 212 230.0

(51) Int. Cl. F03D 13/10; F03D 15/20; F16M 7/00

(52) U.S. Cl. CPC F03D 13/122; F03D 15/20; F16M 7/00; F05B 2240/50

(57) ABSTRACT

A fastening arrangement for fastening a drivetrain to a wind turbine, the fastening arrangement including a housing, a first bearing, and a second bearing. A rotor shaft is rotatably mounted on the housing by the first and second bearings, the first bearing being arranged axially on a rotor-side end region of the housing, the second bearing being arranged axially at a generator-side end region of the housing. The fastening arrangement has a first fastening region in a first axial region, and a second fastening region in a second axial region. The housing is configured to be fastened at the first and second fastening regions to a nacelle of the wind turbine. The second axial region is axially spaced apart from the generator-side end region.

### CROSS REFERENCE TO RELATED APPLICATIONS

This application claims benefit to German Patent Application No. DE 10 2024 212 230.0, filed on Dec. 20, 2024, which is hereby incorporated by reference herein.

### FIELD

The present invention relates to a fastening arrangement for a drivetrain of a wind turbine and to a wind turbine.

### BACKGROUND

Wind turbines are used to generate electricity from wind energy. For this purpose, wind turbines have a rotor. A rotational speed of the rotor is transmitted from a rotor shaft to a gearbox. The rotational speed of the rotor shaft is converted by the gearbox into a rotational speed that is suitable for driving a generator. When the wind turbine is in operation, a rotational speed and the loads acting upon the rotor can fluctuate, for example due to gusts of wind. This can result in vibrations in a drivetrain of the wind turbine, which can cause undesirable acoustic effects such as noise. In addition, these irregular loads can deform parts of the wind turbine, such as the tower, and cause them to vibrate. For example, the tower may be in the form of a hollow body, and deformations and vibrations of this may also cause undesirable acoustic effects such as noise. In addition, vibrations and deformations can increase wear and reduce system efficiency.

These effects are influenced by the placement of bearings for a rotor shaft or other components of the wind turbine drivetrain. However, the bearings must also be arranged according to the loads that occur in order to provide sufficient support for the respective components of the drivetrain. For this reason, components of the drivetrain, such as the rotor shaft with an input shaft of the generator, are often connected elastically to reduce vibrations. However, such elastic connections can wear out quickly and, for example, can only transmit sufficiently high loads if they are of a complex design. Moreover, the elastically connected components have to be fastened separately to the rest of the wind turbine, which may require additional bearings and increase the weight and complexity of the wind turbine.

### SUMMARY

In an embodiment, the present disclosure provides a fastening arrangement for fastening a drivetrain to a wind turbine, the fastening arrangement comprising a housing, a first bearing, and a second bearing. A rotor shaft is rotatably mounted on the housing by the first and second bearings, the first bearing being arranged axially on a rotor-side end region of the housing, the second bearing being arranged axially at a generator-side end region of the housing. The fastening arrangement has a first fastening region in a first axial region, and a second fastening region in a second axial region. The housing is configured to be fastened at the first and second fastening regions to a nacelle of the wind turbine. The second axial region is axially spaced apart from the generator-side end region.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a wind turbine with a drivetrain;

FIG. 2 shows a schematic illustration of a position of fastening regions of a housing relative to bearings for a rotor shaft of the wind turbine in a fastening arrangement for the drivetrain;

FIG. 3 shows, in a plan view from above, a schematic illustration of a positioning of fastening interfaces of the housing on a nacelle of the wind turbine relative to a tower of the wind turbine, with the housing represented only in part;

FIG. 4 shows a schematic illustration of the housing, in a perspective view, with the housing represented only in part;

FIG. 5 shows a schematic illustration of an embodiment of the fastening arrangement in a plan view from above, with the housing represented only in part; and

FIG. 6 shows a schematic illustration of an embodiment of the fastening arrangement in a plan view from above, with the housing represented only in part.

### DETAILED DESCRIPTION

A first aspect of the present disclosure relates to a fastening arrangement for fastening a drivetrain to a wind turbine. The wind turbine can have a tower and a nacelle arranged thereon. The tower extends, for example, with its longitudinal extent in a vertical direction. The nacelle can be mounted, for example in a rotatable or non-rotatable manner, on the tower. The nacelle can be arranged, for example, on the top of the tower. The tower can be of a hollow design, for example. The tower can taper toward its upper end. Thus, for example, the tower can taper conically toward its free end. The tower can also be cylindrical. The tower can have a round, oval or angular cross-section. The tower can be formed, for example, from a plurality of tower elements stacked on top of each other. The tower can comprise as a material, for example, steel and, alternatively or additionally, concrete.

The wind turbine can have, for example, a rotor, a gearbox and a generator. Via the gearbox, the rotor can drive the generator in order to generate electrical energy. The rotor is connected to the gearbox, for example via a rotor shaft. The rotor, the gearbox and the generator can be fastened, for example, to a nacelle of the wind turbine, for example together by a main bearing. The rotor can have a horizontal or vertical axis of rotation. The rotor can have, for example, two, three, four or more rotor blades that are connected to the rotor shaft via a hub. The rotor shaft, the gearbox and the generator can constitute, for example, parts of the drivetrain. The drivetrain can optionally also comprise the rotor and, alternatively or additionally, the brake.

The fastening arrangement has a housing, a first bearing and a second bearing. The housing can be fastened to the nacelle, for example by being bolted to a machine bed. The bearings can be realized, for example, as roller bearings. Suitable bearings are, for example, tapered roller bearings or plain bearings. The rotor shaft is rotatably mounted on the housing by means of the two bearings. This allows the rotor shaft to be supported on the nacelle. The bearings can be arranged, for example, in the housing. The nacelle can comprise, for example, the machine bed to which the drivetrain is fastened. The housing and the two bearings can realize a main bearing of the drivetrain. The main bearing can have no further bearings. The rotor shaft can be mounted on the nacelle only via the main bearing. The gearbox can likewise be mounted on the nacelle only via the main bearing. In this case, for example, stationary components of the housing, such as a gearbox housing, are fastened to the housing. At least one rotatable part, such as an input shaft of the gearbox, can be mounted on the two bearings via the rotor shaft. Optionally, the generator can also be mounted on the nacelle only via the main bearing, for example indirectly via the gearbox.

The housing can be realized as a single piece. The housing can be a cast component or also a forged part. The first bearing is arranged axially on a rotor-side end region of the housing. The first bearing forms, for example, a rotor-side bearing. The second bearing is arranged axially on an end region of the housing on the generator side. The second bearing forms, for example, a generator-side bearing. The two bearings can be axially spaced apart from each other. The two bearings can be arranged coaxially. In the axial region in which the two bearings are arranged, the housing can be made thicker in each case and, alternatively or additionally, stiffened. The housing can have a closed circumferential ring region in the axial region in which the two bearings are arranged. The axial direction and a radial direction can be defined by the axis of rotation of the rotor shaft and, alternatively or additionally, by the axis of rotation of the two bearings. The two bearings can each be fastened in the housing with, for example, a loose fit, transition fit or interference fit with an outer ring. The two bearings can each be fastened to the rotor shaft with, for example, a loose fit, transition fit or interference fit with an inner ring.

The fastening arrangement has a first fastening region in a first axial region. The fastening arrangement has a second fastening region in a second axial region. The housing can be fastened to the fastening regions on a nacelle of the wind turbine. Each of the two fastening regions can be defined, for example, by one or more fastening interfaces by means of which the housing can be connected to the nacelle and is fastened to the nacelle in the assembled state. The fastening interfaces can be realized on and end region of a respective support arm on the nacelle side. The support arms can be connected to the housing. For example, the housing or other components, such as support arms, each have, on the drivetrain side, at least one fastening interface in the first axial region and the second axial region. This can be a flange, shoulder or even just a portion of the housing of the main bearing, by means of which the drivetrain is fastened to the nacelle. The fastening interfaces can have, for example, a supporting surface. The supporting surface can rest, for example, on a part of the nacelle, such as the machine bed. The drivetrain-side fastening interfaces can have through-openings for fasteners such as screws or rivets. The nacelle can have corresponding fastening interfaces for each drivetrain-side fastening interface. For example, the machine bed can have an associated bearing surface for each supporting surface of the drivetrain-side supporting surface. The nacelle-side fastening interface can have through-openings for fasteners such as screws or rivets. The two axial regions, or the two fastening regions, can be axially spaced apart from each other.

The drivetrain can be connected to the nacelle at the fastening interfaces, for example at the corresponding nacelle-side interface. For example, the fastening interfaces on the drivetrain side are bolted, or can be bolted, to the interfaces on the nacelle side. A non-detachable connection can also be provided, such as welding at the fastening interfaces.

The second axial region is axially spaced apart from the generator-side end region. This means, for example, that the second fastening region is also axially spaced apart from the second bearing. For example, the second fastening region can be arranged axially closer to the rotor. For example, the second fastening region can be arranged axially between the first end region and the second end region. In this way, a more load-appropriate position of the second fastening region and the second bearing can be specified. The first axial region is arranged axially, for example, in the rotor-side end region. This means that the first fastening region is then not axially spaced apart from the first bearing. Thus, high loads acting in the upward direction can be well supported due to the weight of the rotor.

In an embodiment of the fastening arrangement, it can be provided that the housing is realized so as to be flexible in an axial region between the second fastening region and the generator-side end region. For example, the housing can be specifically weakened in this axial region by apertures and, alternatively or additionally, by a thin circumferential wall. The housing can deform elastically in this axial region, for example when used as intended, without resulting in plastic deformation. The housing can also have a more flexible material in this axial region than in other axial regions. The transmission of vibrations from the second bearing to the nacelle can thereby be reduced. The housing can also be stiffened by support arms that extend away from the housing and realize fastening interfaces.

In an embodiment of the fastening arrangement, it can be provided that the housing is more flexible in the axial region between the second fastening region and the generator-side end region than in an axial region between the rotor-side end region and the second fastening region. The housing can be realized so as to be stiffer, for example, between the rotor-side end region and the second fastening region than between the second fastening region and the generator-side end region. For example, between the rotor-side end region and the second fastening region the housing can have fewer apertures and, alternatively or additionally, thicker walls than between the second fastening region and the generator-side end region. A stiffer material can also be used here.

In an embodiment of the fastening arrangement, it can be provided that flexibility of the housing is provided by apertures. An aperture can be formed, for example, by a through-opening in a circumferential wall. For example, the housing can have more or larger through-openings in the region between the second fastening region and the generator-side end region than between the rotor-side end region and the second fastening region. Between the rotor-side end region and the second fastening region, the housing can also be without any apertures in its circumferential wall. The housing can thus be particularly light, and of a simple one-piece design. Moreover, the bearings can thus be easily accessible for maintenance and assembly.

In an embodiment of the fastening arrangement, it can be provided that the fastening arrangement realizes at least one fastening interface in each fastening region. At least one of the fastening interfaces can be connected to the housing via a support arm. Also, a plurality of fastening interfaces or all fastening interfaces can be realized by support arms. If a plurality of support arms are provided, the explanations regarding the support arm can apply equally to some or all of these support arms. For example, in the second axial region, two fastening interfaces can each be realized by an associated support arm. The support arms can be realized in one piece with the housing. The support arms can also be fastened to the housing, for example by bolting or welding. The support arms can be realized in one or more parts. An axial position of the fastening interfaces relative to the housing, and thus also relative to an axial position of the bearings, can be freely defined by the support arms. Moreover, a rigid part of the housing, such as the end region with the bearings, can be used to attach the support arms and thus ensure reliable load transfer. Some of the support arms can extend, for example, partially axially.

In an embodiment of the fastening arrangement, it can be provided that the support arm is realized so as to be flexible. For example, the support arm can be thin enough to deform elastically during intended use without causing plastic deformation. For this purpose, the support arm can be of a corresponding geometric design and, alternatively or additionally, an elastic material can be selected. The support arm can be, for example, a metallic component.

In an embodiment of the fastening arrangement, it can be provided that the support arm is more flexible than the axial region of the housing between the rotor-side end region and the second fastening region. Alternatively or additionally, the support arm can be more flexible than the axial region between the second fastening region and the generator-side end region. As a result, the support arm in front of these regions can deform elastically during operation.

In an embodiment of the fastening arrangement, it can be provided that a housing-side end of the support arm is arranged at the generator-side end region. For example, the support arm that realizes a fastening interface in the second fastening region can extend from the generator-side end region. This support arm can extend, for example, from the generator-side end region to the second axial region. This support arm can extend at least partially axially. Alternatively, a support arm that realizes a fastening interface in the first fastening region can extend from the rotor-side end region. This support arm can extend, for example, from the rotor-side end region towards the first axial region. This support arm can extend, for example, only radially, or also at least partially axially.

In an embodiment of the fastening arrangement, it can be provided that the fastening interface is arranged in a region above a circumferential wall of a tower of the wind turbine, for example above a nacelle-side edge of the circumferential wall of the tower. The fastening arrangement can comprise the tower of the wind turbine. The nacelle-side edge can be an upper end of the wall of the tower. In a plan view of the tower along a vertical extent of the tower, the fastening interface can partially cover the nacelle-side edge of the surrounding wall of the tower. In a plane extending orthogonally with respect to a vertical extent of the tower, the fastening interface can at least partially overlap the wall of the tower. The vertical extent can correspond to the longitudinal extent of the tower in the assembled state. In relation to, for example, an axis of symmetry of the tower, which can correspond to the longitudinal axis, the fastening interface can be arranged on the same diameter as an upper edge of the wall of the tower. Bearing forces at the fastening interface that act in a circumferential direction of the tower thus cause only very small deformations of the tower, and therefore also only slight vibrations. Bearing forces at the fastening interface that act in a vertical direction of the tower, for example due to torques about an axis of the rotor shaft, thus likewise cause only very small deformations of the tower, and therefore also only slight vibrations. The wind turbine can thus cause less noise during operation, and moreover the load on the tower can also be less, or at least more appropriate for the structural design. In this way, for example, there can be no need for elastic elements in the drivetrain to reduce vibrations, such as a connection between the rotor shaft and the gearbox input shaft via elastic bolts. This allows the drivetrain to be particularly reliable and low-maintenance.

In an embodiment of the fastening arrangement, it can be provided that the fastening arrangement comprises the drivetrain, which can be realized as described above.

A second aspect relates to a wind turbine that comprises the fastening arrangement according to the first aspect. Respective advantages and further features are given in the description of the first aspect, with designs of the first aspect also forming designs of the second aspect and vice versa. The wind turbine can comprise the tower, the nacelle and the drivetrain. The drivetrain can be fastened the nacelle by means of the fastening arrangement.

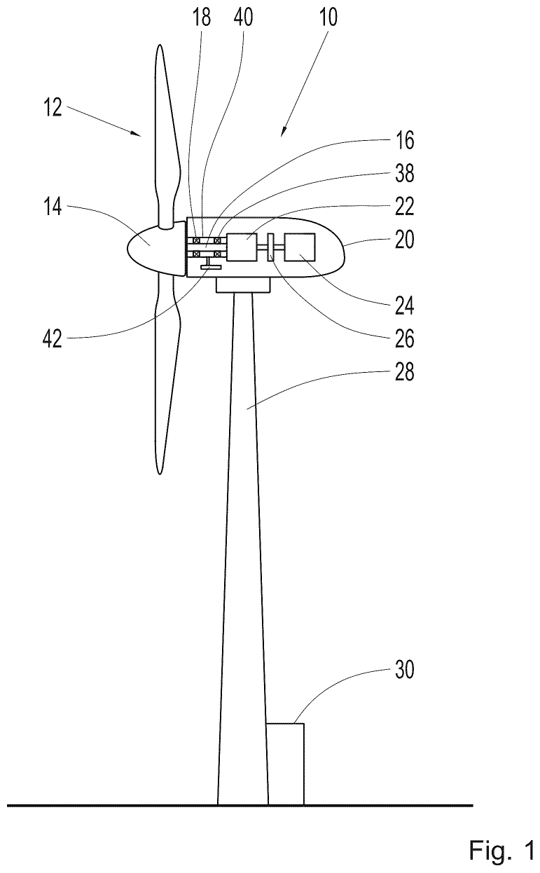

Illustrated in FIG. 1 is a wind turbine 10 having a drivetrain in a horizontal configuration. The wind turbine 10 has a rotor 12 that is held on a rotor shaft 16 via a hub 14. The axis of rotation of the rotor shaft 16 extends substantially horizontally. The rotor shaft 16 is mounted in a nacelle 20 via two roller bearings 18, 38. Provided for this purpose there is a housing 40, which is fastened to a machine bed 42 of the nacelle 20. The rotor shaft 16 is mechanically operatively connected to a generator 24 via a gearbox 22. A brake 26, which acts upon an input shaft of the generator 24, is also arranged in the operative connection between the gearbox 22 and generator 24. The nacelle 20 is rotatably mounted at an upper end of a tower 28, which is anchored to the ground. In a further embodiment, the wind turbine 10 is realized as an off-shore turbine. In addition to the tower 28, the wind turbine 10 has a grid connection 30. A first of the roller bearings 18 faces toward the rotor 12 and is also referred to as the rotor-side bearing 18. A second of the rolling bearings 38 faces toward the generator 24 and is also referred to as the generator-side bearing 18.

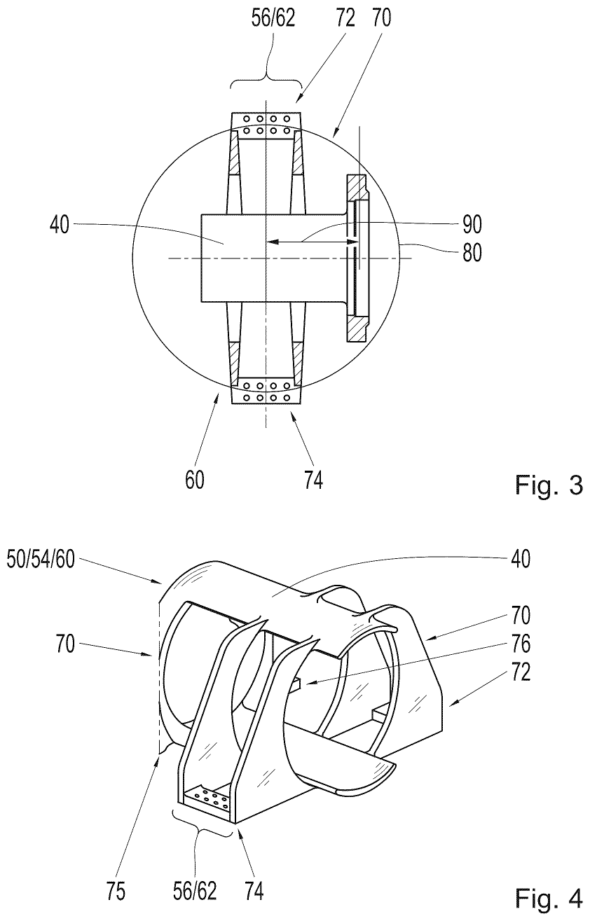

In FIG. 1, the housing 40 on the machine bed 42 is shown arranged at a distance from the tower 28 in a direction that is orthogonal with respect to a vertical extent of the tower 28. As a result, many acting loads are introduced transversely with respect to the vertical extent and also the circumferential extent of the tower 28. FIGS. 3, 5 and 6 illustrate a fastening arrangement for the drivetrain of the wind turbine 10, in which loads are introduced more favorably into the tower 28. The housing 40 in this case is arranged, for example, at least partially above the tower 28. In the embodiments shown, the housing 40 is realized in one piece.

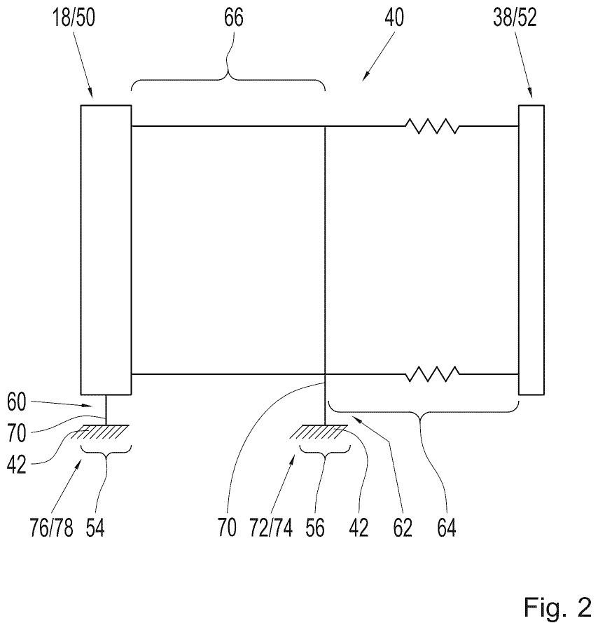

Illustrated in FIG. 2 is a fastening arrangement for the housing 40 on the machine bed 42. Represented on the left in FIG. 2 is an axial and rotor-side end region 50 of the housing 40, which thus faces toward the rotor 12. In the rotor-side end region 50, the first roller bearing 18 is arranged in the housing 40 and, via its outer ring, is supported at least radially against it. Represented on the right is an axial and generator-side end region 52, which thus faces toward the generator 24. In the generator-side end region 52, the second roller bearing 38 is arranged in the housing 40 and, via its outer ring, is supported at least radially against it. In the center, the housing 40 has an axial through-opening, in which the rotor shaft 16 is arranged. The axial and radial direction of rotation is defined by the axis of rotation of the two roller bearings 18, 38 and by the rotor shaft 16 that extends horizontally and centrally from left to right in the image plane of FIG. 2. The fastening arrangement has a first fastening region 60 in a first axial region 54, and a second fastening region 62 in a second axial region 56. The two axial regions 54, 56, and thus also the two fastening regions 60, 62, are spaced apart from one another. The housing 40 is fastened to the nacelle 20 of the wind turbine 10 only in the two fastening regions 60, 62, in this case via the machine bed 42 of the nacelle 20.

The second axial region 56 and thus also the second fastening region 62 are axially spaced from the generator-side end region 52, and thus also from the second roller bearing 38. This results in an axial offset between the second fastening region 62 and the second roller bearing 38, which is illustrated by the arrow 90 in FIGS. 3, 5 and 6. The first axial region 54, and thus also the first fastening region 60, is arranged in the same axial region as the rotor-side end region 50, and thus also the first roller bearing 18. The housing 40 is realized so as to be flexible in an axial region 64 between the second fastening region 62 and the generator-side end region 52. The housing 40 is realized so as to be rigid in an axial region 66 between the rotor-side end region 50 and the second fastening region 62. The housing 40 is more flexible in the axial region 64 between the second fastening region 62 and the generator-side end region 52 than in the axial region 66 between the rotor-side end region 50 and the second fastening region 62. The flexibility varies in the embodiment shown in FIG. 3 and FIG. 4 in that the housing 40 has apertures. In addition, support arms 70 in the first fastening region 60 differ in design from those in the second fastening region 62. The support arms 70 form fastening interfaces 72, 74, 76, 78.

The fastening arrangement has a first fastening interface 72, a second fastening interface 74, a third fastening interface 76 and a fourth fastening interface 78, which are spaced apart from the housing 40 and are each connected to the housing 40 by support arms 70. The four fastening interfaces 72, 74, 76, 78 are all drive-side fastening interfaces 72, 74, 76, 78 and rest on corresponding nacelle-side fastening interfaces of the machine bed 42, are screwed tight for fastening and thus connect the drivetrain to the nacelle 20. For this purpose, the four fastening interfaces 72, 74, 76, 78 have a flat supporting surface and through-openings on the underside. In other embodiments, the supporting surface of the fastening interfaces 72, 74, 76, 78 has shoulders. In the embodiments shown, the drivetrain is mounted to the nacelle 20 only via these four fastening interfaces 72, 74, 76, 78. In other embodiments, there are further fastening interfaces. The four fastening interfaces 72, 74, 76, 78 are each connected to the housing 40 via an associated support arm 70. Here, the housing 40 is formed in one piece with the support arms 70. In FIG. 2 and FIG. 3, the axis of rotation of the rotor shaft 16 extends from left to right in the plane of the image.

Furthermore, illustrated in FIG. 3 is a nacelle-side edge 80 of a circumferential wall of the tower 28. The nacelle-side edge 80 is formed by an upper, and thus nacelle-side, end of the tower 28, that in the present case realizes an end face of the tower 28. The first and the second fastening interface 72, 74 are each arranged, in the vertical direction of the tower 28, in a region above the nacelle-side edge 80 of the circumferential wall of the tower 28. In the vertical extent of the tower 28, the first and the second fastening interface 72, 74 are thus arranged directly above the nacelle-side edge 80 of the circumferential wall of the tower 28. In addition, a direction of main extent of the first and second fastening interfaces 72, 74 extends tangentially with respect to the circumferential wall of the tower 28. The direction of main extent in this case corresponds to a line of symmetry between the two rows of through-openings on the first and the second fastening interface 72, 74 and runs parallel between the longer sides of the supporting surface, which here has a rectangular shape. An end region of the two associated support arms 70 on the fastening interface side extends orthogonally with respect to this direction of main extent. The third and the fourth fastening interface 76, 78 are arranged spaced apart from the nacelle-side edge 80 of the circumferential wall of the tower 28.

In a plan view (see FIG. 3), the support arms 70 for the first and the second fastening interface 72, 74 extend orthogonally and thus radially with respect to the axis of rotation of the rotor shaft 16, and are connected to the housing 40 in the second axial region 56. In the embodiment of FIG. 3 and FIG. 4, these support arms 70 are formed by two axially spaced arms that have no axial extent between the fastening interfaces 72, 74 and the housing 40. The support arms 70 for the first and the second fastening interface 72, 74 are thus arranged with their end on the fastening interface end and their housing-side end in the same axial region, here namely the second axial region 56. The support arms 70 for the third and the fourth fastening interface 76, 78 extend orthogonally with respect to the axis of rotation of the rotor shaft 16, and are connected to the housing 40 in the first axial region 54 (see FIG. 3). Accordingly, support arms 70 for the third and the fourth fastening interface 76, 78 terminate on both sides in the first axial region 54. These support arms 70 are each formed by an arm. The support arms 70 for the third and the fourth fastening interface 76, 78 are more solid and stiffer than the two spaced-apart arms of the support arms 70 for the first and the second fastening interfaces 72, 74, which in comparison are more flexible.

The four fastening interfaces 72, 74, 76, 78 are spaced apart from the axis of rotation of the rotor shaft 16 of the wind turbine 10 in a plane that extends orthogonally with respect to the vertical extent of the tower 28. This plane corresponds to the image plane of FIGS. 3, 5 and 6.

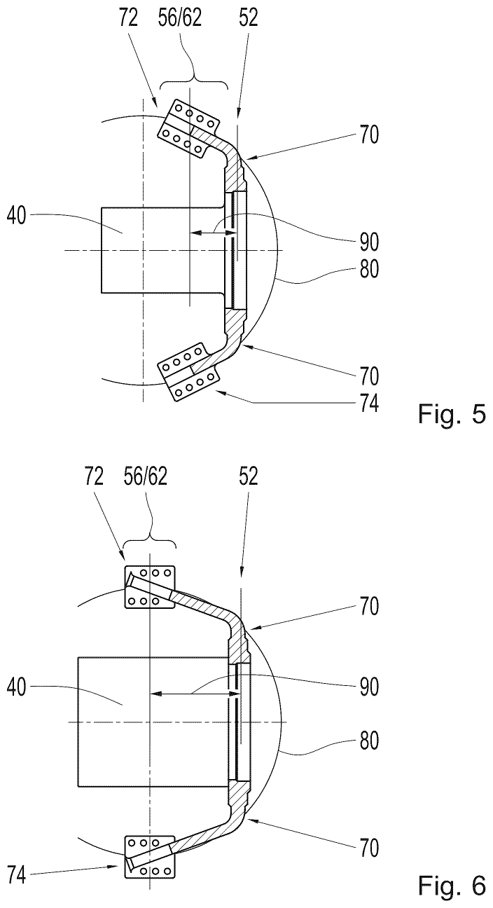

FIG. 5 shows a second embodiment of the fastening arrangement that is similar to the embodiment described above. Only the differences are explained. The support arms 70 for the first and the second fastening interface 72, 74 now extend away from the generator-side end region 52 of the housing. The support arms 70 in this case initially extend radially within the generator-side end region 52 up to a kink. After the kink, these support arms 70 then also extend with an axial portion up to the first and the second fastening interface 72, 74, respectively. This sub-region of these support arms 70 after the kink extends, in the region of the fastening interfaces 72, 74, tangentially with respect to the nacelle-side edge 80 of the circumferential wall of the tower 28. In this embodiment, the support arms 70 for the first and the second fastening interface 72, 74 are thus arranged axially with a housing-side end in the generator-side end region 52 and with a fastening-interface-side end in the second axial region 56. These support arms 70 are also not realized with two arms, but each have only one arm.

In the embodiment of FIG. 3, the first and the second fastening interface 72, 74 are arranged in a 12 o'clock and 6 o'clock position in the plan view of the tower 28, provided that it is assumed that the axis of rotation of the rotor shaft 16 extends through the 9 o'clock and 3 o'clock positions. In the embodiment of FIG. 5, on the other hand, the first and the second fastening interface 72, 74 are arranged in the 1 o'clock and 5 o'clock positions. The offset between the second fastening region 62 and the generator-side end region 52 of the housing 40 is therefore smaller.

FIG. 6 shows a third embodiment of the fastening arrangement that is similar to the two embodiments described above. In the plan view, the first and the second fastening interface 72, 74 are located in the 12 o'clock and 6 o'clock positions, as in the embodiment of FIG. 3. The offset between the second fastening region 62 and the generator-side end region 52 of the housing 40 is thus as large as in the embodiment of FIG. 3. However, the support arms 70 for the first and the second fastening interface 72, 74 are connected to the housing 40 in the generator-side end region 52, as in the embodiment of FIG. 5. These support arms 70 are likewise realized with one arm. The support arms 70 likewise initially extend within the generator-side end region 52 up to a kink, orthogonally with respect to the axis of rotation of the rotor shaft 16. After the kink, these support arms 70 then also extend with an axial portion up to the first and the second fastening interface 72, 74, respectively. However, this sub-region of these support arms 70 after the kink does not extend tangentially with respect to the nacelle-side edge 80 of the circumferential wall of the tower 28 in the region of the fastening interfaces 72, 74, but at an angle with respect to the tangential direction.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE DESIGNATIONS

10 wind turbine
12 rotor
14 hub
16 rotor shaft
18 roller bearing
20 nacelle
22 gearbox
24 generator
26 brake
28 tower
30 grid connection
38 roller bearing
40 housing
42 machine bed
50 end region
52 generator-side end region
54 first axial region
56 second axial region
60 first fastening region
62 second fastening region
64 axial region
66 axial region
70 support arms
72 first fastening interface
74 second fastening interface
76 third fastening interface
78 fourth fastening interface
80 edge
90 arrow

1. A fastening arrangement for fastening a drivetrain to a wind turbine, the fastening arrangement comprising:
a housing;
a first bearing; and
a second bearing,
wherein a rotor shaft is rotatably mounted on the housing by the first and second bearings, the first bearing being arranged axially on a rotor-side end region of the housing, the second bearing being arranged axially at a generator-side end region of the housing,
wherein the fastening arrangement has a first fastening region in a first axial region, and a second fastening region in a second axial region,
wherein the housing is configured to be fastened at the first and second fastening regions to a nacelle of the wind turbine, and
wherein the second axial region is axially spaced apart from the generator-side end region.

2. The fastening arrangement as claimed in claim 1, wherein the housing is configured to be flexible in a third axial region between the second fastening region and the generator-side end region.

3. The fastening arrangement as claimed in claim 2, wherein the housing is more flexible in the third axial region between the second fastening region and the generator-side end region than in a fourth axial region between the rotor-side end region and the second fastening region.

4. The fastening arrangement as claimed in claim 2, wherein a flexibility of the housing is provided by apertures.

5. The fastening arrangement as claimed in claim 1, wherein the fastening arrangement includes at least one fastening interface in each of the first and second fastening regions, at least one of the fastening interfaces being connected to the housing via a support arm.

6. The fastening arrangement as claimed in claim 5, wherein the support arm is configured to be flexible.

7. The fastening arrangement as claimed in claim 6, wherein the support arm is more flexible than the fourth axial region of the housing between the rotor-side end region and the second fastening region.

8. The fastening arrangement as claimed in claim 5, wherein a housing-side end of the support arm is arranged at the generator-side end region.

9. The fastening arrangement as claimed in claim 5, wherein the fastening arrangement comprises a tower of the wind turbine and the at least one fastening interface is arranged in a region above a circumferential wall of the tower of the wind turbine.

10. A wind turbine comprising the fastening arrangement as claimed in claim 1.
